(19) United States
(12) Patent Application Publication
(10) Pub. No.: US 2025/0324947 A1
(43) Pub. Date: Oct. 23, 2025

(54) MULTI-FUNCTIONAL PET HARNESS SYSTEM WITH ADJUSTABLE LIGHTING FOR ENHANCING SAFETY

(71) Applicant: Jeffrey Freeman, Los Angeles, CA (US)

(72) Inventor: Jeffrey Freeman, Los Angeles, CA (US)

(21) Appl. No.: 19/038,187

(22) Filed: Jan. 27, 2025

Related U.S. Application Data
(60) Provisional application No. 63/636,684, filed on Apr. 19, 2024.

(51) Int. Cl. A01K 27/00; F21V 23/00; F21V 23/02; F21Y 115/10

(52) U.S. Cl. CPC A01K 27/006; A01K 27/002; F21V 23/007; F21V 23/023; F21Y 2115/10

(57) ABSTRACT

An illuminating pet harness and system are provided. The harness has a back strap, girth strap, and chest strap. A light source, such as a light-emitting diode (LED) strip, is disposed on the chest strap and operable in multiple modes including full brightness, reduced brightness, and flashing in order to illuminate a path in front of a pet wearing the harness. The LED may be operable to emit light between 800 and 1100 lumens. Means for powering the LED strip are provided and may include a rechargeable battery pack, securable to the back strap, and configured with means for controlling the LED light strip. The harness may further comprise a handle disposed on the back for added control, padded straps for comfort, and reflective material along the back, girth, and chest straps for visibility. The LED strip enhances visibility up to 200 meters, ensuring safety for pets and owners.

### GOVERNMENT CONTRACT

Not applicable.

### CROSS-REFERENCE TO RELATED APPLICATIONS

This application claims benefits of U.S. Patent Application No. 63/636,684, filed on Apr. 19, 2024, which is incorporated herein by reference.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to devices for adjusting lighting intensity and, more particularly, to a multifunctional device configured as an external power source and controller for a light and comprising global positioning system and pedometer, and accelerometer.

### BACKGROUND

Walking, or simply getting out and moving around the community-whether on foot, in a wheelchair, or by similar means-offers numerous benefits, including improvements to mood, psychological well-being, and cardiovascular health, among others. It also fulfills a vital need for dogs. Regular walks are essential for a dog's physical health, mental stimulation, and behavior training. The ease and accessibility of this activity, therefore, make it a highly recommended way to enhance overall health and wellness for owners and their pets.

Many prefer or need to take walks at night due to personal schedules or their pet's preferences. However, nighttime walking presents visibility challenges. It can be difficult for others to see either or both of the pet and the owner. In addition, it can be challenging for the pet and/or owner to navigate their path, avoid obstacles, and steer clear of potential dangers in their environment.

When thought and effort are put in to increasing visibility in low light, many resort to wearing reflective gear. This includes leashes, as well as vests and other accessories for both humans and pets, that are designed to reflectively illuminate when hit by an external light source, such as car headlights and street lamps. Thus far, reflective gear has been deficient as a solution to visibility in low light since it depends on external light sources to make the owner and pet visible to others. Some have therefore proposed electrically lighting devices worn by the pet and/or human. For instance, U.S. Pat. No. 6,170,959 to Richardson teaches a wrap or sleeve comprising flashing or blinking lights that can be worn by people or pets during periods of limited visibility. U.S. Pat. Nos. 9,980,466 and 10,182,556 and to Osher et al. disclose various aspects of a selectively illuminating leash that comprises a wireless lighting assembly along its entire length. Still, although these improve others' ability to perceive the wearer, they are not particularly well suited to improving the wearer's perception of their surroundings. In addition, they may not be suitably operative to adjust the light's intensity to meet the wearer and/or pets' individualized lighting requirements.

In addition, none of these proposals propose means for suitably adjusting a light source that also incorporates “smart” features such as fitness tracking, interactive capabilities, and safety enhancements, which may be particularly beneficial to those walking at night.

Thus, although various proposals have been made to improve visibility during night time walks, none of those in existence combine the characteristics of the present invention. Therefore, there remains a need for a self-contained, multi-functional light adjusting device and a system that enables making pets and owners more visible to others, enables illuminating the wearer's surroundings in order to improve the wearer's ability to see and navigate their surroundings, and includes.

### SUMMARY

The present disclosure is directed to a multi-functional light adjusting device and pet harness and system configured to enhance the safety, mobility and visibility of the wearer, such as a dog, by brightly illuminating a path with a light-emitting diode (LED) strip capable of operating in multiple modes, while also providing features such as reflective materials, padded straps for comfort, and a rechargeable power source to ensure reliable and extended use in various environmental conditions.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In one embodiment, the pet harness for enhancing safety comprises a harness body, a light source, means for powering the light source, and means for controlling operation of the light source.

In some embodiments, the pet harness comprises a harness body having a back strap, a girth strap, and a chest strap. The girth strap may be removably securable to the back strap from one or more ends in order to ergonomically avoid any need of a pet, such as a mobility limited pet, to step into the harness. In some embodiments, portions of the back strap and chest strap can comprise one or more snaps, buckles, or other fasteners to effectuate this functionality. The chest strap may be adjustably secured to the back strap. Means for adjusting the chest strap and girth strap, such as slide buckles known to those of ordinary skill in the art, may be provided.

The light source may be an LED strip be positioned along an outer surface of the harness to direct its light in front of the wearer. As such, it is contemplated that the light source may be disposed on an outer surface of the chest strap. In some embodiments, placement of the light source will correspond with an upper portion of the wearer's chest, just beneath their throat. Additionally, reflective material, such as reflective tapes, cording, trim, piping, and the like, comprising any material suitable for the purpose, may be applied along the outer surface of the back strap, girth strap, and chest strap of the harness body for enhanced visibility. The light source may be configured to emit light with an intensity sufficient to illuminate a distance in front of the system wearer up to about 100 meters, up to about 150 meters, or even up to about 200 meters depending on the exact positioning and angle of the light source and external surrounding conditions. The light source may be further configured to emit light with an intensity that is visible up to about one quarter of a mile away. In some embodiments, the light source may be configured to emit light with an intensity ranging from approximately 800 to 1100 lumens.

The means for supplying power to the light source may comprise an onboard battery, however, in some embodiments, it may be preferable for the means for supplying power to be a rechargeable battery that is securable to a portion of the harness body, such as the back strap and operative to supply power to the light source via a power cord. It is contemplated that providing rechargeable means for powering the LED will, for instance, eliminate the need for disposable batteries and ensure that the light source remains functional without frequent battery replacements, which could be inconveniently frequent given the light intensity achieved by the light source in certain embodiments. In some embodiments, the battery may be configured to effectively charge via standard power outlets and/or USB, such as USB-C, ports as needed, easily maintaining the system for consistent visibility during evening walks or low-light conditions.

In some embodiments, the means for supplying power and the means for controlling the operation of the light source may be enclosed within a single housing. This housing may feature a display and one or more input controls, such as buttons or sliders, that enable operation of the light source. The light source may be configured to operate in at least one of several modes, including full brightness, reduced brightness, and flashing. As such, it is contemplated that the light source mode may be activated or altered by manipulation of the housing.

In some embodiments, a Bluetooth module may be provided in order to enable remote operation from, for example, a smart phone.

In some embodiments, the display is configured to show information such as battery level, Bluetooth status, GPS coordinates, step counts and other descriptive information relating to the multiple functions of device and system. The type and quality of information appearing on any display, however, shall not limit the invention. The foregoing are provided for example only and not limitation.

The pet harness may further include a cord retention mechanism to secure the power cord along a portion of the harness body, as well as a handle positioned on the back strap for added convenience. At least one of the back strap, girth strap, or chest strap may be padded for comfort.

It is contemplated that providing a multi-functional pet harness system with adjustable lighting according to this disclosure may provide a fully integrated means of protecting a wearer and any companions by improving visibility.

Thus, it is an object of the invention to support outdoor activity in a safe manner.

It is another object of the invention to aid pets with low visibility.

It is another object of the invention to aid pets and their owners having biological and/or situational vision impairments.

It is still another object of the invention to improve accessibility of outdoor activities in low light conditions.

It is an object of the invention to provide general utility across a variety of places and terrains including dog parks, beaches, community sidewalks, streets, trails, and wooded areas among others.

It is an object of the invention to improve the wellbeing of pets and their owners by enabling increased access to the outdoors as well as community engagement and health data.

One or more of the above-disclosed embodiments, in addition to certain alternatives, are provided in further detail below with reference to the attached figures. The disclosed subject matter is not, however, limited to any particular embodiment disclosed.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure.

Moreover, embodiments and limitations disclosed herein are not dedicated to the public under the doctrine of dedication if the embodiments and/or limitations: (1) are not expressly claimed in any claims stemming from this disclosure; and/or (2) are potentially equivalents of express elements and/or limitations in such claims under the doctrine of equivalents

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a perspective view of an exemplary multi-functional light adjusting device and pet harness system in accordance with one embodiment.

FIG. 2 shows an exploded view of an exemplary multi-functional light adjusting device and pet harness system in accordance with another embodiment.

FIGS. 3A and 3B are schematic diagrams illustrating certain embodiments of the exemplary multi-functional light adjusting device comprising a plurality of module or component parts.

FIG. 4 show one exemplary embodiment of the multi-functional light adjusting device and pet harness system in use.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

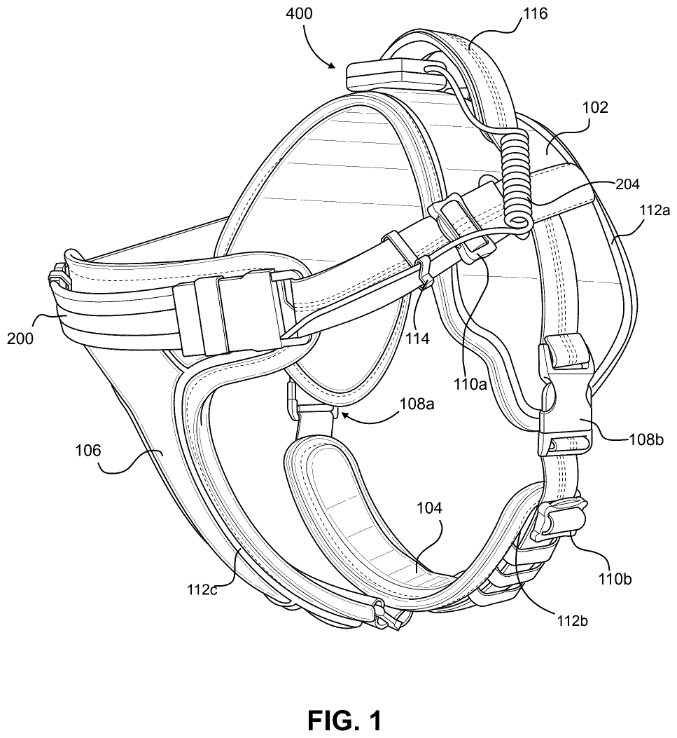

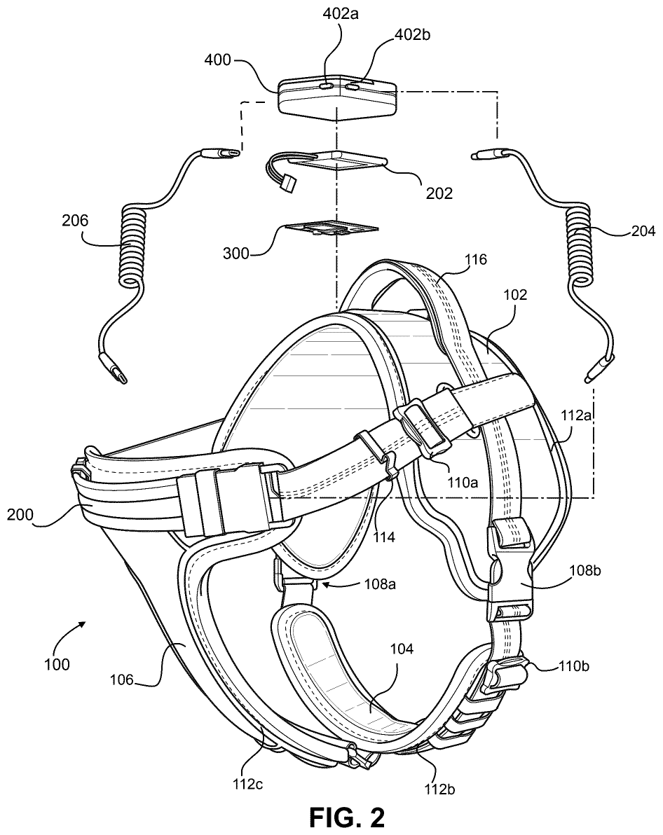

With reference to FIGS. 1 and 2 an embodiment of the multi-functional pet harness system may comprise, harness body 100, a light source, means for powering the light source, and means for controlling operation of the light source (referred to alternatively throughout as the “controller”).

The harness body 100 may have a back strap 102, arranged to correspond with a wearer's back, a girth strap 104, arranged to encircle the wearer's body opposite their back, and a chest strap 106, arranged to correspond with the wearer's chest. The wearer may be a dog, though it is contemplated that the device and system may be provided in any size or configuration as needed to accommodate a variety of pets. Therefore, “dog” will be referenced throughout this description for simplicity and not limitation.

The girth strap 104 may be removably securable to the back strap 102 from one or more ends in order to ergonomically avoid any need of a pet, such as a mobility limited pet, to step into the harness. In some embodiments, portions of the back strap and chest strap can comprise one or more complementary fasteners, such as buckles 108a, 108b, to effectuate this functionality. The chest strap 106 may be adjustably secured to the back strap. Means for adjusting the chest strap and girth strap, such as slide buckles 110a, 110b known to those of ordinary skill in the art, may be provided.

The light source may be an LED strip 200 may positioned along an outer surface of the harness to direct its light in front of the wearer. As such, it is contemplated that the light source may be disposed on an outer surface of the chest strap 106. In some embodiments, placement of the exemplary LED strip 200 will correspond with an upper portion of the wearer's chest, just beneath their throat. Additionally, reflective material, such as reflective tapes, stitches, cording, trim, piping, and the like, comprising any material suitable for the purpose, may be applied along the outer surface of the back strap, girth strap, and chest strap of the harness body, as at character references 112a, 112b, 112c for enhanced visibility.

The means for supplying power to the LED strip 200 may comprise an onboard battery, however, in some embodiments, it may be preferable for the means for supplying power to be a rechargeable battery 202 that is securable to a portion of the harness body 100, such as the back strap 102 and operative to supply power to the LED strip 200 via a power cord 204. FIG. 2 shows a spiral cable as the power cord 204. It is contemplated that this will keep the power cord compact and tidy while in use and while charging, while allowing it to stretch and contract when needed to accommodate the size and movement of a harness wearer. However, any suitable power cord may be used without departing from the invention.

It is contemplated that providing rechargeable means for powering the LED strip 200 will, for instance, eliminate the need for disposable batteries and ensure that the LED strip 200 remains functional without frequent battery replacements. Indeed, single use battery changes could be be inconveniently frequent given the light intensity achieved by the LED strip 200 in certain embodiments contemplated under this disclosure. As such, in some embodiments, the battery may be configured to effectively charge via standard power outlets and/or USB, such as USB-C, ports and cables 206 as needed, allowing a user to readily maintain power in the system for consistent visibility during evening walks or use in low-light conditions.

In some embodiments, the means for supplying power and the means for controlling the operation of the LED strip 200, such as microcontroller 300 may be enclosed within a single housing 400. The housing 400 may feature a display (obscured) and one or more input controls, such as buttons 402a, 402b or sliders, that enable operation of the LED strip 200. The LED strip 200 may be configured to operate in at least one of several modes, including full brightness, reduced brightness, and flashing. As such, it is contemplated that the LED strip 200 mode may be activated or altered by manipulation of the housing 400.

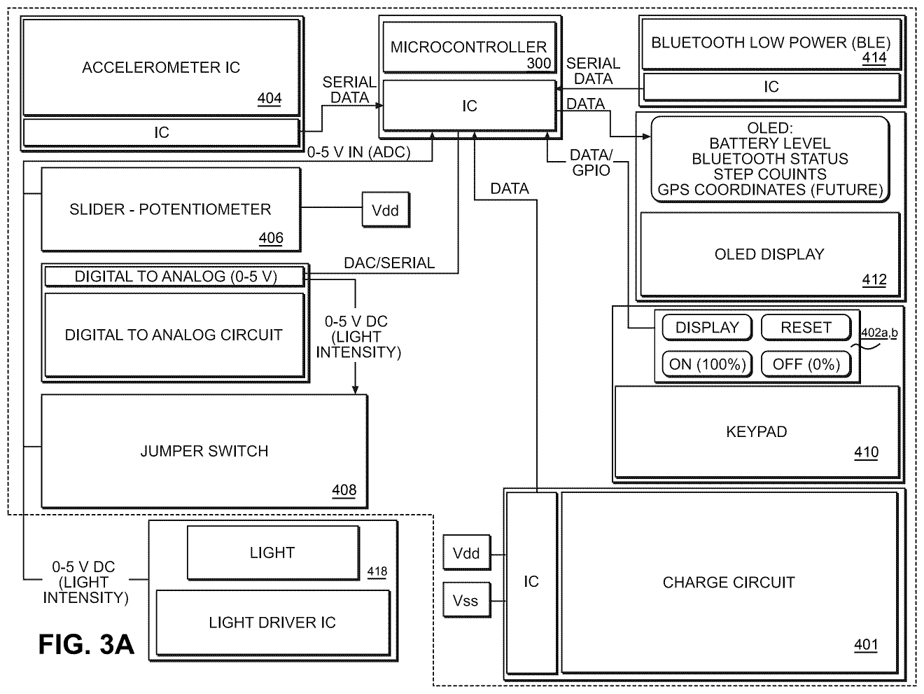

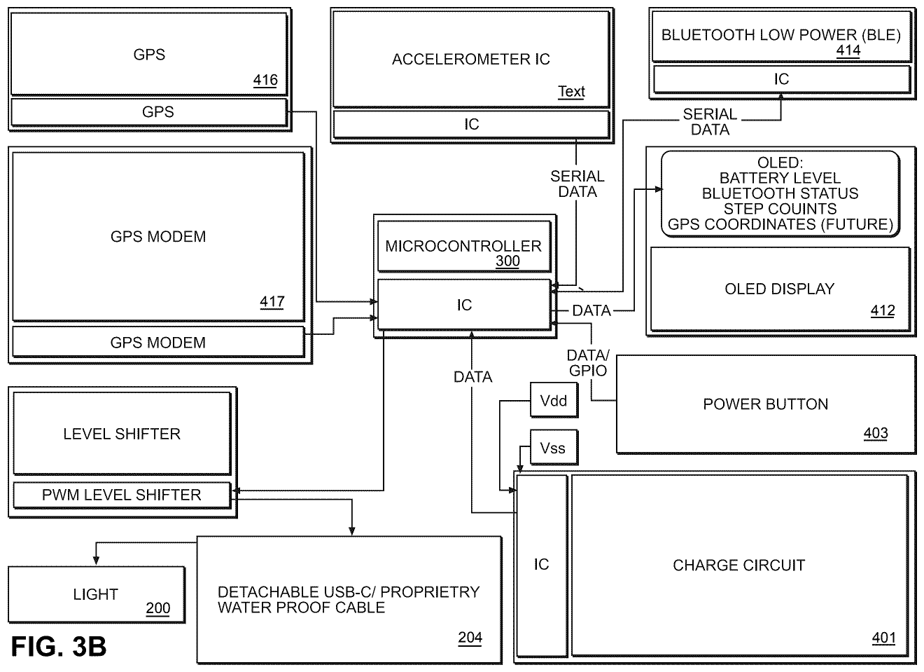

FIGS. 3A and 3B are schematic diagrams illustrating certain embodiments of the exemplary multi-functional pet harness system with adjustable lighting for enhanced safety comprising a plurality of module or component parts enclosed within the housing and which may be provided to enable the variety of functions referenced below. Namely, the housing comprising the multi-functional pet harness system with adjustable lighting for enhanced safety may contain any combination of the battery (not shown, but controlled by the charge circuit 401), and a microcontroller 300, accelerometer 404, potentiometer 406, jumper (DIP) switch 408, keypad 410, including any buttons 402a, 402b, 403 display 412, Bluetooth enabling microchip 414, GPS microchip 416 or GPS modem 417 configured to transmit over a wireless communication network, (such as a LTE, GSM, or WIFI network or other communications network known to those of ordinary skill in the art), and light source module 418.

Operation of any of the foregoing modules contained in the housing may be coordinated by an integrated circuit (“IC”) various modules, such as sensors, the microcontroller, Bluetooth module, and charge circuit. One of ordinary skill in the art will recognize that the IC may serve as the central component for processing, control and communication among any connected modules. The number, types, and functionality of modules contained within the housing may vary based on need and preference and will not limit the invention.

Notably, FIG. 3B shows the light 200 of FIGS. 1 and 2 and power cord 204 in communication with level shifter 420. That is FIGS. 3A and 3B illustrate alternative operational setups. One of ordinary skill in the art will recognize that countless operational set ups are possible without departing from the invention. Neither one or the other will limit the invention and are provided for the purpose of enabling the invention and providing clarifying examples only.

In some embodiments, the housing may comprise various sensors to enable functionality of the system. For instance only and without limitation, the housing may be configured to enable powering the light source, such as the LED strip, on or off via short or long taps to predetermined portions of the housing. In addition, and without limitation, it is contemplated that the intensity of the light source may be adjusted via physical interaction with the housing such as by pressing and holding a particular portion of the housing for a predetermined amount of time.

As such, the housing may further comprise buttons, a slider, an OLED screen, and any ports necessary to charge the battery and even, where desired, physically connect the housing to the light source to provide power to the light source and even enable adjustment of the lighting intensity or mode. It is contemplated that any physical connection to the light source may be secure but readily disconnectable. In addition, it is contemplated that any connectors, such as any LED power cables, comprise waterproof locking connectors. These may be additionally resistant to the encroachment of dust and particulate.

In some embodiments, the display, configured to show information such as battery level, Bluetooth status, GPS coordinates, step counts and other descriptive information relating to the multiple functions of device and system, as applicable. The type and quality of information appearing on any display, however, shall not limit the invention. The foregoing are provided for example only and not limitation.

The housing may be waterproof or at least water resistant, however, the housing 400 of FIGS. 1 and 2 is merely provided as an example, and one of ordinary skill in the art will recognize that the housing may comprise a variety of shapes, sizes, colors, materials, and the like without departing from the invention. Of course, one of ordinary skill in the art will recognize that the housing 400 will be sized to contain all modules, buttons, displays, sliders, ports, batteries, etc. as needed. Thus, the size of the housing will not be limited by the disclosure.

The manner of securing the housing 400 to the harness body 100 will not limit the invention, however, for the sake of example only and not limitation, it is contemplated that complementary snaps, hook and loop fasteners, interlocking fasteners, or claps may be disposed on the housing 400 and harness body 100. In some embodiments, a pocket sized to securely receive the housing 400 may be integrated on some portion of the harness body.

The harness body 100 may further include a cord retention mechanism 114 to secure the power cord along a portion of the harness body, as well as a handle positioned 116 on the back strap for added convenience and safety for the purpose of supporting or controlling the dog or other wearer.

At least one of the back strap 102, girth strap 104, or chest strap 106 may be padded for comfort, as needed or desired.

The LED strip 200 may be configured to emit light with an intensity sufficient to illuminate a distance in front of the harness up to about 100 meters, up to about 150 meters, or even up to about 200 meters depending on the positioning and angle of the LED strip 200 and external surrounding conditions. The LED strip 200 may be further configured to emit light with an intensity that is visible up to about one quarter of a mile away. In some embodiments, the LED strip 200 may be configured to emit light with an intensity ranging from approximately 800 to 1100 lumens.

Turning again to FIGS. 3A and 3B, in some embodiments, the controller may be is configured as one element in a smart system, wherein the means for supplying power to the light source, or LED strip includes integrated Bluetooth functionality, enabling control of the device via a smartphone application and supporting additional smart features.

For example, in some embodiments, a wireless communications module, such as the Bluetooth enabling microchip 302 may permit the controller to wirelessly communicate with a user's personal computing device, such as a smartphone. In some embodiments, the Bluetooth module or other wireless communications module may enable adjustment of the intensity of the light source as well as transfer of any data, such as GPS and pedometer data, displayed on the device to a user's mobile electronic device so that such data may be seamlessly integrated with or accessed by, for example, a smart phone application. In some embodiments, the device may be operative to connect to a local Wi-Fi network and transfer any data collected or sensed to the cloud.

In an exemplary embodiment, the system utilizes the microcontroller 300 to turn on and off the light source or LED strip, by a light module that is configured to control the light source. In some embodiments, the light source is integrated on a dog harness. Indeed, the light source may be integrated into a frontward portion of the harness configured to align with a dog's lower neck between the dog's front shoulders. In some embodiments, the light source is a flexible LED strip operative to selectively emit up to or over about 1000 lumens in order to provide an ultrawide light coverage of the area in front of the dog or other animal wearing the harness. In some embodiments, such illumination may extend visibility up to about a quarter of a mile, beneficially illuminating the path ahead while conspicuously marking the presence of the wearer.

The microcontroller may further communicate to the plurality of modules as sensors and inputs, such as a pedometer configured to read steps taken by the holder of the controller; GPS operative to receive the holder's physical location; keypad configured to set up, reset, and power the controller as well as adjust the intensity of a connected LED strip, such as the 1000 lumen light disposed on the harness; a slider potentiometer operative to power LED strip source and adjust its intensity; and charge socket for reading the status of the battery and its connectivity to power. In addition to the foregoing exemplary inputs, the microcontroller may be operative to communicate with output modules such as the display configured to show pedometer data, GPS location, light intensity level set point, battery status and charge level; the communications module such as the Bluetooth module configured to transfer display data; and LED module driver configured to provide power to the light source and enable adjustment to the lighting intensity.

In some embodiments, the controller may be integrated with a mobile software application, enabling the activation of additional security features and facilitating community engagement among users. More particularly, the controller in the multi-functional pet harness system may be part of a networked environment in which one embodiment of a system for adjusting a lighting device, tracking fitness, and enhancing safety is implemented. In some embodiments, such a system may comprise a plurality of multi-functional pet harness system controllers and even smartphones and other computing devices that can use one or more of various communications types such as, for example and without limitation, cellular and Wi-Fi and Bluetooth communications.

Respective users of each device may be members of a social network that enables them to interact with each other using their light adjusting devices and exchange information related to their walks. For instance, users may alert one another to the presence of certain dangerous conditions, including but not limited to any predators that have been observed or dangerous topographical conditions to be aware of. Indeed, user's may generally converse with one another and coordinate outdoor activities and off-app social engagement as well. In one exemplary embodiment, the social network may be facilitated by a website that is hosted by a social network server that facilitates interaction among a limited group of members, as may be established by the members themselves. For the purpose of the present example, the limited group of members may include the users of the light adjusting devices.

In an embodiment, a software application, whether web-based or mobile, may be configured to enable or perform the following non-limited, exemplary listing of tasks: tracking the location of the controller in the multi-functional pet harness; tracking the movement of such device, such as the path traversed by the holder of the device; tracking the number of steps taken by the holder; identifying optimal or preferred walking paths such as less crowded walking paths; communicating with other members of the network; receiving notifications and notifying other members as to local hazards; and managing support tickets.

Although Wi-Fi communications are contemplated, one of ordinary skill in the art will recognize that certain aspects of the invention may be configured to operate even if internet access is limited without departing from the invention.

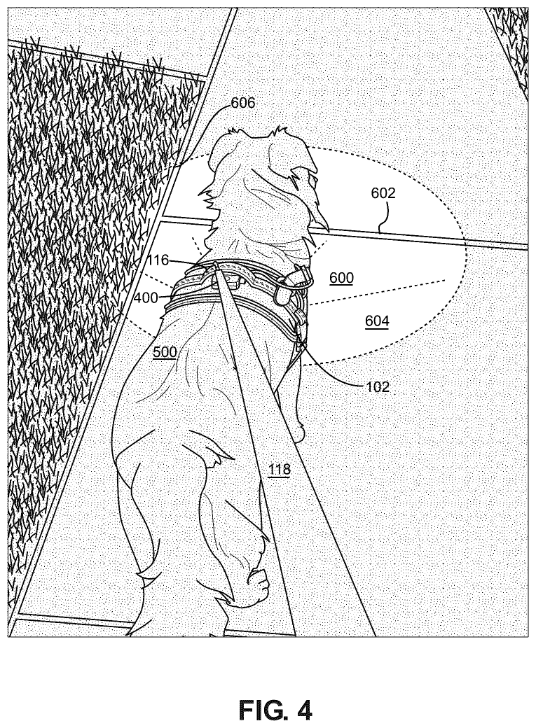

FIG. 4 provides an exemplary scene demonstrating one embodiment of the multi-functional pet harness system in use. In particular, an embodiment of the harness 100 is shown on the body of an exemplary dog 500, in which the back strap 102 is visible. A leash 112 may be connected to the handle 116, or d ring, or other feature disposed on the harness 100. The LED strip, obscured by the body of the dog 500 illuminates an area 600 in front of the dog, including, for instance, a crack 602 or boundary in a walkway 604 as well as a boundary to a lawn 606. This illumination improves the visibility of these potential obstacles for both the dog 500 and its walker. In addition, light coming from the LED strip may be visible to other walkers, pedestrians, motorists, and the like that may be approaching. Exemplary means for powering and controlling the LED strip, such as contained in housing 400 appear in this embodiment to be disposed on the back strap 102 of the harness for ease of accessibility to the walker, though it is possible that such means may be disposed elsewhere along the harness body, such as in a pocket or the like on any other portion of the harness body.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### Conclusions, Ramifications, and Scope

While certain embodiments of the invention have been illustrated and described, various modifications are contemplated and can be made without departing from the spirit and scope of the invention. For example, the harness, light emitting diode, and battery pack may be any color without departing from the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the multi-functional pet harness system with adjustable lighting for enhanced safety with which that terminology is associated. In general, the terms used in the following claims should not be constructed to limit the multi-functional pet harness system with adjustable lighting for enhanced safety to the specific embodiments disclosed in the specification unless the above description section explicitly define such terms. Accordingly, the actual scope encompasses not only the disclosed embodiments, but also all equivalent ways of practicing or implementing the disclosed system and apparatus. The above description of embodiments of the multi-functional pet harness system with adjustable lighting for enhanced safety is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the multi-functional pet harness system with adjustable lighting for enhanced safety for enhancing safety.

What is claimed is:

1. A pet harness, comprising:
a harness body having a back strap, a girth strap removably securable to the back strap, and chest strap adjustably secured to the back strap;
a light source disposed along an outer surface of the chest strap, configured to operate in at least one of a plurality of modes comprising at least full brightness, reduced of brightness, and flashing;
wherein the light source is configured to electrically communicate with means for supplying power to the source; and
wherein the light source is configured to electrically communicate with means for controlling the operation of the light source.

2. The pet harness of claim 1, wherein the means for supplying power to the light source comprises a rechargeable battery pack securable to the back strap and operative to supply power to the light source via a power cord.

3. The pet harness of claim 2, wherein means for supplying power to the light source and means for controlling the operation of the light source are enclosed within a housing comprising a display and one or more input controls configured to effectuate operation of the light source.

4. The pet harness of claim 2, further comprising a cord retention mechanism for retaining the power cord along a portion of the harness body.

5. The pet harness of claim 1, further comprising a handle disposed on the back strap.

6. The pet harness of claim 1, wherein at least one of the back strap, girth strap, and chest strap is padded.

7. The pet harness of claim 1, further comprising reflective material disposed along an outer surface of each of the back strap, girth strap, and chest strap.

8. The pet harness of claim 1, wherein the light source is configured to emit light with an intensity ranging from about 800 to about 1100 lumens.

9. The pet harness of claim 1, wherein the light source is a light emitting diode (LED) strip.

10. A system for enhancing safety, comprising:
a harness for a pet, the harness having a body defined by a back strap, an adjustable girth strap releasably securable to the back strap, and a chest strap adjustably secured to the back strap;
a light source disposed on a forward-facing outer surface of the harness, configured to emit light with an intensity of about 800 to about 1100 lumens, and configured to operate in at least one of a plurality of modes comprising at least full brightness, reduced of brightness, and flashing;
means for powering the light source; and
means for controlling the operation of the light source.

11. The system of claim 10, wherein the light source is a light emitting diode (LED) strip.

12. The system of claim 10, wherein the chest strap is padded and is T-shaped, extending from a central portion of the girth strap, the girth strap having a first and second ends configured to be removably secured to first and second ends of the back strap.

13. The system of claim 10, wherein means for powering the light source and means for controlling the operation of the light source are enclosed within a housing comprising a display and one or more input controls configured to effectuate operation of the light source.

14. The system of claim 13, further comprising at least one additional module within the housing selected from the group consisting of an accelerometer configured to detect motion of the harness, a Bluetooth-enabled microchip configured to allow remote control of the light source via a wireless connection to an external device, and a GPS module configured to transmit location data over a wireless communication network.

15. The system of claim 10, wherein the harness further comprises reflective material disposed along an outer surface of each of the back strap, girth strap, and chest strap.
